(19) United States
(12) Patent Application Publication
(10) Pub. No.: US 2025/0040763 A1
(43) Pub. Date: Feb. 6, 2025

(54) COUNTERTOP APPLIANCE WITH PHYSICAL AND REMOTE MOTOR CONTROL

(71) Applicant: WHIRLPOOL CORPORATION, BENTON HARBOR, MI (US)

(72) Inventors: ERIC A. HILL, CHICAGO, IL (US); RICHARD J. HUGHES, COLOMA, MI (US); BRANDON T. MOCK, ST. JOSEPH, MI (US); RYAN JAMES RUTTER, ST. JOSEPH, MI (US)

(21) Appl. No.: 18/735,650

(22) Filed: Jun. 6, 2024

Related U.S. Application Data
(60) Provisional application No. 63/529,892, filed on Jul. 31, 2023.

(51) Int. Cl. A47J 43/044; A47J 43/08

(52) U.S. Cl. CPC A47J 43/044; A47J 43/082; A47J 2043/04472

(57) ABSTRACT

A countertop appliance is provided that has a motor and an actuator for setting an operational criteria of the motor, such as motor speed. The position of the actuator can be set physically by a user adjacent to the countertop appliance or via a signal received from a remote device, such as a smartphone or a home automation device. If a signal is received remotely, the physical position of the actuator is updated to show the updated operational criteria of the motor for the countertop appliance. An option feature of a confirmation interface is provided on a housing for the countertop appliance in which a user adjacent to the countertop appliance can confirm or reject an update to the operational criteria of the motor.

### CROSS-REFERENCE TO RELATED APPLICATIONS

This application claims priority to and the benefit of U.S. Provisional Patent Application No. 63/529,892 filed Jul. 31, 2023, which is incorporated herein by reference in its entirety.

### FIELD OF THE INVENTION

The invention relates to a small appliance, such as a stand mixer, that has a motor speed actuator that is movable physically by a user or by remote control by a handheld device or home automation device.

### BACKGROUND

Small countertop or kitchen appliances, such as stand mixers, blenders, or food processors by example, have become ubiquitous in both a home and commercial kitchen setting. In the example of a stand mixer, one generally comprises a base having a lower extension platform on which a mixing bowl is typically mounted or placed and an upper portion which houses a motor housing connected to a motor housing. The motor housing is typically movable with respect to the base between a lowered position in which a rotatable attachment mount is juxtaposed with a mixing bowl placed upon the lower extension platform and an upper position where the rotatable mount is moved away from the mixing bowl to allow ingredients to be placed within the mixing bowl. Alternatively, the mixing bowl can be liftable with respect to the rotatable mount so that the mixing bowl can be lifted toward and away from it.

One desirable feature of countertop appliances such as stand mixers, food processors and blenders, is the number of convenient and helpful food preparation features that they can perform. However, each of these typical countertop appliances requires a user to be physically present next to the countertop appliance for controlling operating criteria of the countertop appliance, such as motor speed.

### BRIEF SUMMARY

In one aspect of the invention a countertop appliance comprises a base having a lower surface for resting on a work surface and an upper portion, the lower surface having an extension upon which a mixing bowl can be placed for food preparation operations performed by the countertop appliance. A housing can comprise a rotatable attachment mount and a motor can have an output shaft operably connected to the attachment mount and configured to provide rotational motion to the attachment mount when powered. An actuator can be mounted to at least one of the base or the housing and operably interconnected with the motor, the actuator having a handle movable along a path that is accessible from the exterior of the countertop appliance by a user and a positioning assembly configured to impart movement to the handle of the actuator along the path upon receipt of a position signal by the positioning assembly. A wireless communication interface can be operably interconnected with the positioning assembly adapted to provide the position signal to the positioning assembly. Upon receipt of the position signal by the positioning assembly or physical movement of the handle of the actuator by a user, the handle of the actuator can be moved between a plurality of positions to generate a signal from the actuator to the motor representative of a speed of the output shaft of the motor.

Various embodiments of the invention are also contemplated without departing from the scope of this invention. The wireless communication interface can be at least one of Wi-Fi or Bluetooth communication protocols. The handle of the actuator can comprise a knob. The path along which the handle of the actuator moves can be linear or arcuate.

A tactile confirmation interface having at least one visual indicator thereon that is accessible by a user from the exterior of the countertop appliance can be operably interconnected between the actuator and the motor. The visual indicator can be controllable between a first inactive state and a second active state. A signal interrupt that prevents any position signals from affecting the position of the handle along the elongated housing can be provided when the visual interface of the tactile interface is set to the second active state. The confirmation interface can be configured to return the visual indicator to the first inactive state upon receipt of a first gesture from a user and any pending position signals are processed by the actuator. The confirmation interface can be configured to return the visual indicator to the first inactive state upon receipt of a second gesture from a user and any pending position signals are canceled by the actuator.

The actuator can comprise an elongated housing having a first end and a second end and the handle is mounted for movement to the elongated housing between the first and second ends thereof. The handle can include at least one of a flange and a slot, and the elongated housing can include the other of the flange and a slot, and the flange can be mounted for slidable movement within the slot to define the path. The positioning assembly can comprise a positioning motor controllable by the position signal, and an output of the motor can be operably interconnected to the handle of the actuator to impart movement thereto representative of the position signal.

The output of the positioning motor can further comprise a gear, the elongated housing can comprise a belt mounted for movement imparted from rotation of the gear by the motor, and movement of the belt can impart slidable movement of the handle with respect to the elongated housing. The output of the positioning motor can further comprise a gear rotatable by the positioning motor and the handle can further comprise a rack gear engaged with the gear of the positioning motor. Rotation of the positioning motor gear can impart lateral movement of the handle with respect to the elongated housing. The output of the positioning motor can further comprise a worm gear extending along the general direction of the elongated housing and the handle can further comprise a gear engaged with the worm gear. Rotation of the positioning motor worm gear can impart lateral movement of the handle with respect to the elongated housing.

In another aspect of the invention, a countertop appliance can comprise a base having a lower surface for resting on a work surface and an upper portion. The lower surface can have an extension upon which a mixing bowl can be placed for food preparation operations performed by the countertop appliance. A housing therefor can comprise a rotatable attachment mount, movably connected to a portion of the base between at least a first position wherein the attachment mount is juxtaposed with the extension on the lower surface of the base, and a second position wherein the attachment mount is raised away from the extension on the lower surface of the base. A motor can have an output shaft operably connected to the attachment mount and can be configured to provide rotational motion to the attachment mount when powered. An actuator can be mounted to at least one of the base or the housing and operably interconnected with the motor. The actuator can have a handle movable along a path that is accessible from the exterior of the countertop appliance by a user and a positioning assembly configured to impart movement to the handle of the actuator along the path upon receipt of a position signal by the positioning assembly. The actuator can comprise a first end and a second end and the handle can be mounted for movement between the first and second ends thereof. A wireless communication interface can be operably interconnected with the positioning assembly and can be adapted to provide the position signal to the positioning assembly.

Upon receipt of the position signal by the positioning assembly or physical movement of the handle of the actuator by a user, the handle of actuator can move between a plurality of positions to generate a signal from the actuator to the motor representative of a speed of the output shaft of the motor.

Additional embodiments of the invention are also contemplated without departing from the scope of this invention. The positioning assembly can comprise a positioning motor controllable by the position signal, and an output of the motor can be operably interconnected to the handle of the actuator to impart movement thereto representative of the position signal. The output of the positioning motor can further comprise a gear, the elongated housing can comprise a belt mounted for movement imparted from rotation of the gear by the motor, and the belt can impart slidable movement of the handle with respect to the elongated housing. The countertop appliance can comprise a stand mixer and the rotatable accessory mount can be adapted to receive a mixing accessory.

### BRIEF DESCRIPTION OF THE DRAWINGS

In the drawings:

FIG. 1 shows a side elevational view of a countertop appliance according to the invention having an operational criteria actuator that is operable by touch by a physical user as well as by remote control using a smartphone device or a home automation device.

FIG. 2 is a schematic diagram showing features of the countertop appliance shown in FIG. 1 in which a motor for performing food preparation operations is provided with an actuator which can control a feature or operational criteria of the motor, such as motor speed, either by a physical touch by a user or a remote device.

FIGS. 3A-3B show an example first embodiment of the actuator for the countertop appliance shown in FIGS. 1-2.

FIGS. 4A-4B show an example second embodiment of the actuator for the countertop appliance shown in FIGS. 1-2

FIGS. 5A-5B show an example third embodiment of the actuator for the countertop appliance shown in FIGS. 1-2.

FIG. 6 shows a side elevational view of a user updating the physical setting of the actuator for the countertop appliance shown in FIGS. 1-2.

FIG. 7A shows a side elevational view of the countertop appliance of FIGS. 1-2, specifically showing a user updating a virtual representation of the actuator for the countertop appliance on a smartphone device, wherein the smartphone is emitting a signal to the countertop appliance shown in FIGS. 1-2.

FIG. 7B shows an optional stage in which the countertop appliance shows a confirmation interface in an active state, identifying that a signal has been received to alter the operating criteria of the countertop appliance and requesting that a user provide a confirmation of that signal to the countertop appliance.

FIG. 7C shows the physical position of the actuator for the countertop appliance moving to the position specified on the remote device.

FIG. 8A shows a user emitting a voice command to a home automation device and that home automation device emitting a wireless signal to the countertop appliance shown in FIGS. 1-2 indicative of a or representative of a new operating criteria setting, such as motor speed, of the countertop appliance shown in FIGS. 1-2.

FIG. 8B shows an optional step in which the received signal as illustrated in FIG. 8A causes a confirmation interface to have a visual indicator to a user that a signal representative of a new operating criteria for the countertop appliance, such as motor speed, has been received and a visual indicator shows to a user to provide a confirmation to the countertop appliance shown in FIGS. 1-2.

FIG. 8C shows, following the receipt of a confirmation gesture from the user in FIG. 8B, the physical location of the actuator moving to the new requested position for the countertop appliance shown in FIGS. 1-2.

### DETAILED DESCRIPTION

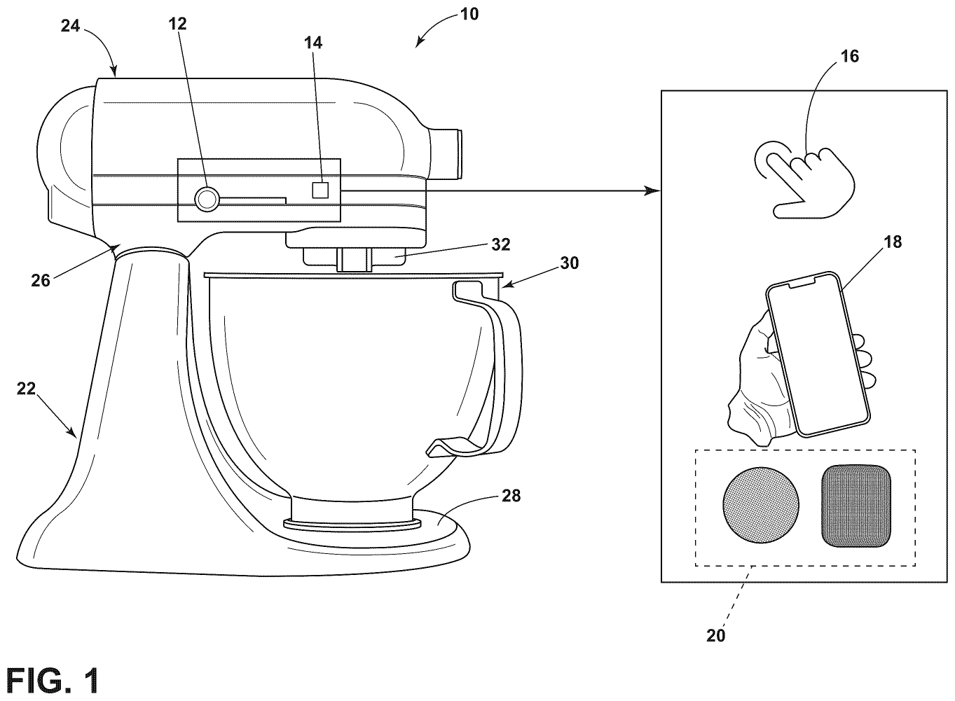

Turning now to the drawings and to FIG. 1 in particular, a countertop appliance 10 is shown. The countertop appliance 10 has an actuator 12 for controlling an operating feature of the countertop appliance, such as motor speed, in the example shown in this invention. A confirmation interface 14 is an optional component provided on the countertop appliance 10 in accordance with the invention for allowing a user to confirm receipt of an actuator position signal received remotely by the countertop appliance 10. It will be understood by one skilled in the art that the confirmation interface 14 can be any number of suitable components for receiving at least one gesture from a user of the countertop appliance to indicate a positive or negative reaction to the receipt of a positioning signal for the actuator 12, including but not limited to a toggle button, a touch screen, and the like. As shown in FIG. 1, the actuator 12 can be positioned by a user's hand 16 with direct physical contact with the actuator 12 to provide an indication to the actuator of a new setting for the actuator 12. It is also a feature of this invention that a remote signal can be provided to the actuator 12 from any number of remote locations, that would be apparent to one skilled in the art. In the illustrative embodiment shown in FIG. 1, the remote positioning signal for the actuator 12 can come from a smartphone 18 or a home automation device 20, such as an Alexa system or an Apple HomePod or the like.

It will be understood by one skilled in the art that the remote positioning signal for the actuator 12 coming from a smartphone 18 or a home automation device 20 may have a suitable interface thereon which allows a user to, for example, see the current position of the actuator 12 for the countertop appliance 10 and to provide either physical gestures in the case of a smartphone 18 or voice or other wireless commands to the home automation device 20 in a manner which would be apparent to one skilled in the art.

It will also be apparent to one skilled in the art that the countertop appliance shown in FIG. 1 is a typical stand mixer, but that other countertop appliances could be provided with the actuator 12 that can receive a physical input from the user's hand 16 or receiving remote positioning signals from the smartphone 18 or home automation device 20. Other countertop appliances that could be fitted with the actuator 12 and optional confirmation interface 14 include a blender, food processor, and the like, without departing from the scope of this invention.

By way of example and not by limitation, the countertop appliance 10 shown in FIG. 1 comprises a base 22 that is pivotally connected at an upper portion thereof to a motor housing 24 via an upper portion 26. The base 22, in the example shown in FIG. 1, has a lower portion with a platform 28 that typically can receive a mixing bowl 30 placed thereon. The mixing bowl 30 can be any typical vessel for receiving foodstuffs to be mixed within the mixing bowl 30 in a manner apparent to one skilled in the art. The motor housing 24 typically includes a rotatable accessory mount 32 adapted to releasably receive various mixing accessories, such as beaters, blades, mixing hooks, kneaders, and other implements that would be apparent to one skilled in the art.

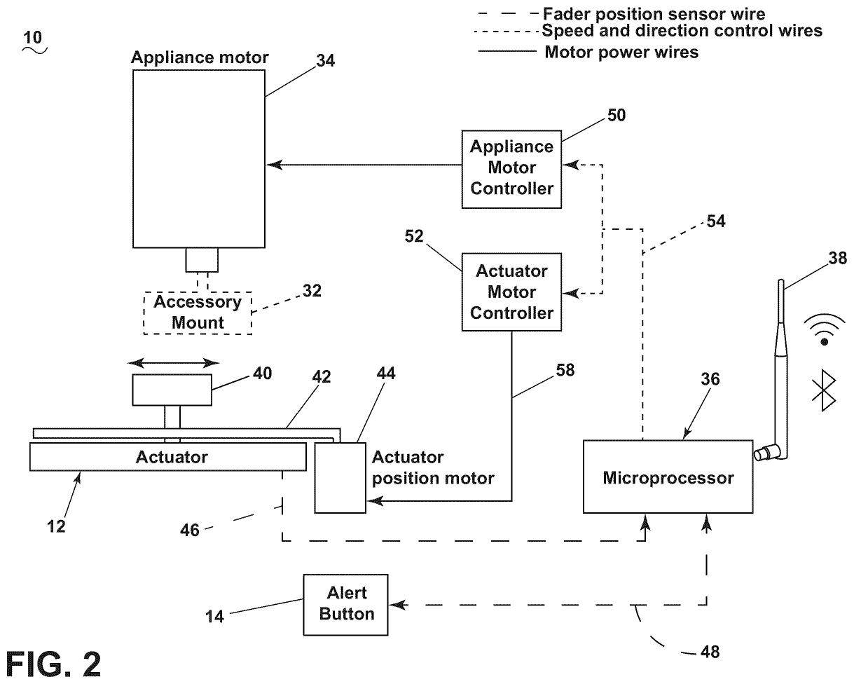

Turning to the schematic shown in FIG. 2, additional detail for internal componentry carried within the countertop appliance 10 is shown. It would be apparent to one skilled in the art that the componentry may be contained anywhere within, or associated with, the countertop appliance 10 including, but not limited to, within the base 22 or the motor housing 24 without departing from the scope or spirit of the invention. While countertop appliances such as that shown herein can have a number of operating criteria, the illustrative examples shown in FIGS. 1-2 use motor speed as an example criterion. Other operating criteria that would be apparent to one skilled in the art could be chosen without departing from the scope of the invention.

FIG. 2 shows an appliance motor 34 in schematic form. It will be understood that this appliance motor is operably interconnected to the accessory mount 32, shown in FIG. 1 but not shown in FIG. 2, via suitable mechanical interconnection so that rotational motion created by the appliance motor 34 is imparted to the accessory mount 32 to perform desired food preparation operations with the countertop appliance 10. The particulars of the example schematic shown in FIG. 2 will now be described. It will be understood by one skilled in the art that the focus of the invention is to allow for physical movement of the actuator 12 by both physical touch by a user's hand 16 and via remote signals, such as those transmitted by a smartphone 18 or a home automation device 20, or other devices that would be apparent to one skilled in the art (e.g., via Raspberry Pi, etc.). It will be apparent to one skilled in the art that other or different components could be used to accomplish the same function than those shown in FIG. 2 and the example shown in FIG. 2 should not be construed as limiting upon the scope of the invention.

A microprocessor 36 is shown in FIG. 2 comprising a transceiver 38 capable of receiving a remote positioning signal for the actuator 12. Example icons for Wi-Fi and Bluetooth wireless signals are shown adjacent to the transceiver 38, but those protocols should be construed by way of example and not by limitation, as other wireless protocols and methods by which a remote signal could be received by the microprocessor 36 through the transceiver 38 would be apparent to one skilled in the art.

The various componentry of the countertop appliance 10 are shown in FIG. 2 including the actuator 12 and the confirmation interface 14. The actuator 12 comprises a handle 40 mounted for movement with respect to an elongated housing 42 wherein the position of the handle 40 with respect to the elongated housing 42 is representative of an operating criterion of the appliance motor 34. The actuator 12 is provided with an actuator position motor 44 that is operably interconnected to the handle 40 by a suitable linkage whereby rotational movement of the actuator position motor 44 can impart movement of the handle 40 with respect to the elongated housing 42 of the actuator 12. The relative position of the handle 40 with respect to the elongated housing 42 is provided to the microprocessor 36 by an actuator position sensor 46 in a manner that would be apparent to one skilled in the art.

The confirmation interface 14 is preferably switchable between at least two states: a first inactive state in which a disabled visual indication is provided to a user of the countertop appliance 10 and a second active state, in which a visual indication is provided to a user of the countertop appliance 10 to provide a call to action to interact with the confirmation interface 14. The confirmation interface 14 is preferably configured to allow for multiple gestures to be received from a user of the countertop appliance 10, including, but not limited to, a first gesture in which a user can provide a confirmation indication to the confirmation interface 14 representative of an intention that the user is confirming an action displayed by the confirmation interface 14, and a second gesture, in which a user can provide a cancel indication to the confirmation interface 14 representative of an interaction with the user has an intention to cancel the action displayed by the confirmation interface 14. The state of the confirmation interface is communicated to the microprocessor via the confirmation interface signal 48 in a manner which would be apparent to one skill in the art.

An appliance motor controller 50 and an actuator motor controller 52 are also operably interconnected with the microprocessor 36 in a manner that would be apparent to one skilled in the art. The interconnection between the microprocessor 36 and the appliance motor controller 50 and the actuator motor controller 52 is shown generally by reference numeral 54. In this manner, upon issuance of the signal by the microprocessor 36 through the controller interconnection 54, to the appliance motor controller 50 and the actuator motor controller 52, an operating criterion of the appliance motor 34 and the actuator 12 can be set in a manner known to one skilled in the art. For example, a signal from the microprocessor 36 through the controller interconnector 54 to the appliance motor controller 50 can provide a signal through a motor interconnection 56 to set operating criteria of the appliance motor 34, such as motor speed. In addition, a signal from the microprocessor 36 through the controller interconnector 54 to the actuator motor controller 52 can also provide a signal through an actuator interconnection 58 to set the position of the handle 40 with respect to the elongated housing 42 of the actuator 12. In this manner, whether a user manually updates the position of the handle 40 with respect to the elongated housing 42 of the actuator 12 or a remote device provides a signal via the transceiver 38 to the microprocessor 36, the position of the handle 40 with respect to the elongated housing 42 of the actuator 12 can have the currently set operating condition, such as motor speed, visually set on and visible from the exterior of the countertop appliance 10.

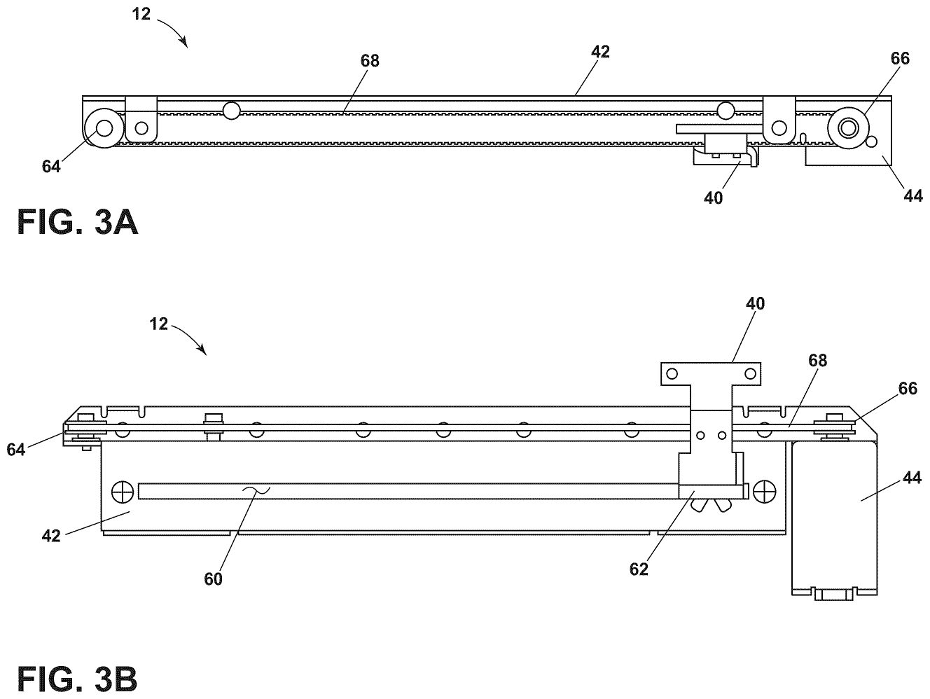

Turning now to FIGS. 3A-3B, 4A-4B and 5A-5B, particular embodiments of the actuator 12 that can have the position of the handle 40 set either physically by a user or remotely by communication from a smartphone 18 or an external home automation device 20, will now be described. The embodiments shown in these Figures are referenced with common reference numerals for components common between these Figures and with reference to the schematic diagram of FIG. 2. In each of these embodiments, the handle 40 is mounted for movement with respect to the elongated housing 42 of the actuator 12 and the position of the handle 40 with respect to the elongated housing 42 is communicated in each case via the actuator position sensor 46 (not shown in the arrangements of FIGS. 3A-3B, 4A-4B and 5A-5B).

Turning to a first physical embodiment of the actuator 12 of FIGS. 3A-3B, the elongated housing 42 is provided with a slot 60 in which a flange 62 of the handle 40 is mounted for movement within the slot 60. A first pulley 64 and a second pulley 66 are mounted for rotational movement to opposite ends of the elongated housing 42 and extends along a longitudinal length of the slot 60. A belt 68 is disposed around the first pulley 64 and second pulley 66. A handle pulley 70 is mounted to the handle 40 and has a corresponding inter-engagement with the belt 68, whereby movement of the belt 68 around the first pulley 64 and second pulley 66 imparts lateral movement of the handle 40 via the engagement of the belt 68 with the handle pulley 70. At least one of the first pulley 64 and second pulley 66 are operably interconnected to the actuator position motor 44 so that rotational movement provided by the actuator position motor 44 is imparted to the connected pulleys 64, 66 to move the belt 68, and thereby the handle pulley 70 on the handle 40 to reset the position of the handle 40 in a controlled manner by the movement of the flange 62 of the handle 40 within the slot 60. One example of a suitable product embodying the actuator 12 shown in FIGS. 3A-3B is a PSM Series Motorized Slide Potentiometer available from Bourns Pro Audio.

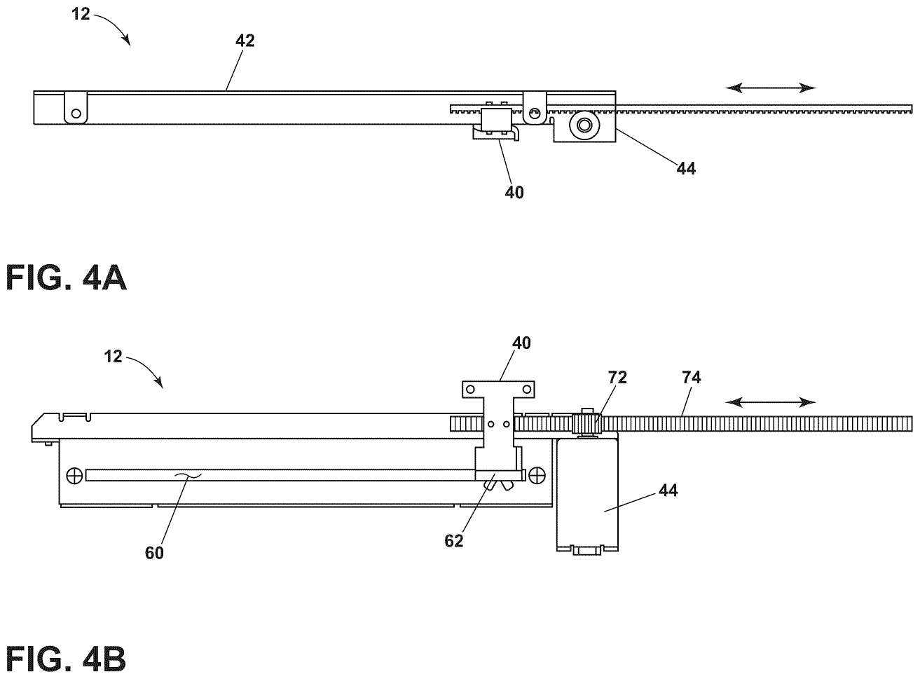

Turning to FIGS. 4A-4B, a second embodiment of the actuator 12 is shown with a slightly different configuration than that shown in the first embodiment of FIGS. 3A-3B. In the embodiment shown in FIGS. 4A-4B, a slot 60 is also provided in the elongated housing 42 and the handle 40 is also provided with a flange 62 mounted for movement along the path defined by the slot 60. The actuator position motor 44 is provided with a gear 72 on an output shaft thereof and a rack gear 74 is mounted with respect to the elongated housing for lateral movement as a result of engagement with the gear 72. A portion of the rack 74 is mounted to the handle 40 so that, as the gear 72 on the output shaft of the actuator position motor 44 rotates, the handle 40 travels laterally due to its affixation to the rack 74 in a path defined by the flange 62 within the path defined by the slot 60.

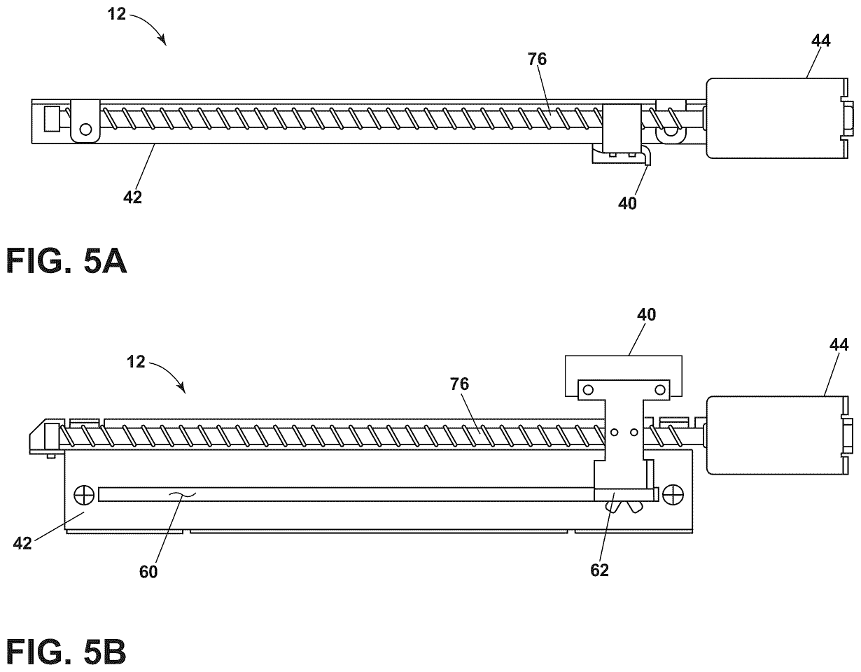

Turning to the embodiment of the actuator 12 of FIGS. 5A-5B, the handle 40 is also provided with a flange 62 located within at least a portion of the path defined by a slot 60 in the elongated housing 42. An output shaft of the actuator position motor 44 is provided with a worm gear 76 that has a typical spiral spur as would be known to one skilled in the art. The handle 40 has a corresponding interconnected number, such as a spur gear or pulley wheel having at least one tooth engaged within the spiral path defined by the worm gear 76. Thus, upon rotation of the output shaft of the actuator position motor 44 the worm gear 76 is provided with corresponding rotational movement which moves the handle laterally within the path defined by the slot 62 of the handle 40 as captured within the path defined by the slot 60 in a manner that would be apparent to one skilled in the art.

With respect to the embodiments of the actuator 12 shown in FIGS. 3A-3B, 4A, 4B, and 5A-5B, the handle 40 can be physically moved with respect to the actuator position motor 44 by a user from the exterior of the countertop appliance 10. Conversely, the position of the handle 40 can also be adjusted by the rotation of the actuator position motor 44. In either event, the relative position of the handle 40 with respect to the elongated housing 42 of the actuator 12 is communicated to the microprocessor 36 by the actuator position sensor 46 in a manner that would be apparent to one skilled in the art.

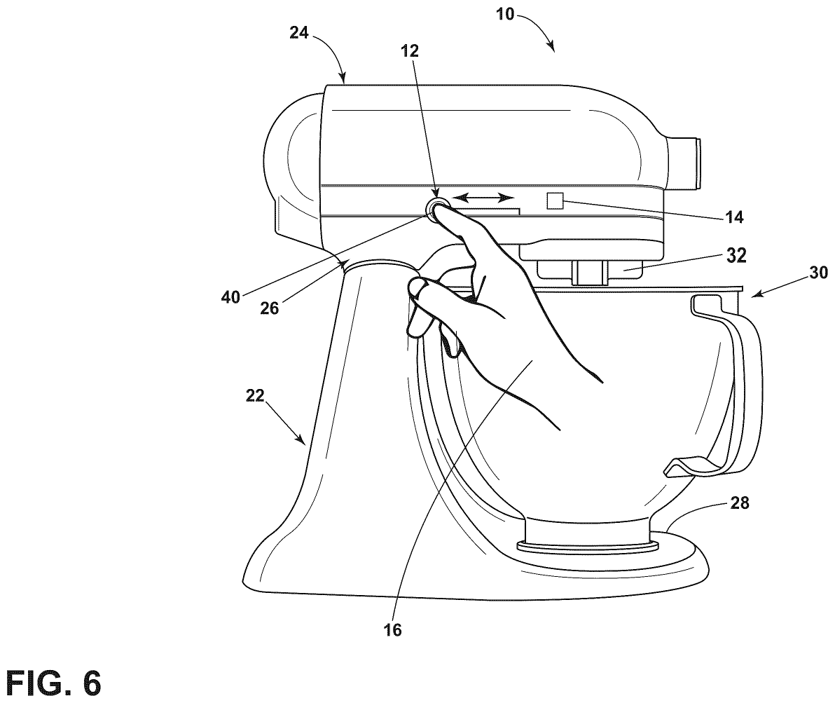

Examples of use of the countertop appliance 10 will now be provided with reference to FIGS. 6, 7A, 7B, 7C, 8A, 8B and 8C.

In a typical use, a user can provide an indication of an updated operational criteria of the appliance motor 34 (not shown in FIG. 6) by adjusting the physical position with the user's hand shown in an illustrative example by reference 16 in FIG. 6. By virtue of the adjustment of the physical location of the handle 40 with respect to the actuator 12, a signal is generated by the actuator position sensor 46 and communicated to the microprocessor 36. In the manner described above, the microprocessor sends a signal through the controller interconnection 54 to the appliance motor controller 50 and the actuator motor controller 52 in a manner which would be apparent to one skilled in the art. Through motor interconnection 56, the new operational criteria of the appliance motor 34, such as motor speed, is updated and the countertop appliance 10 will operate with the new setting for the updated operational criteria.

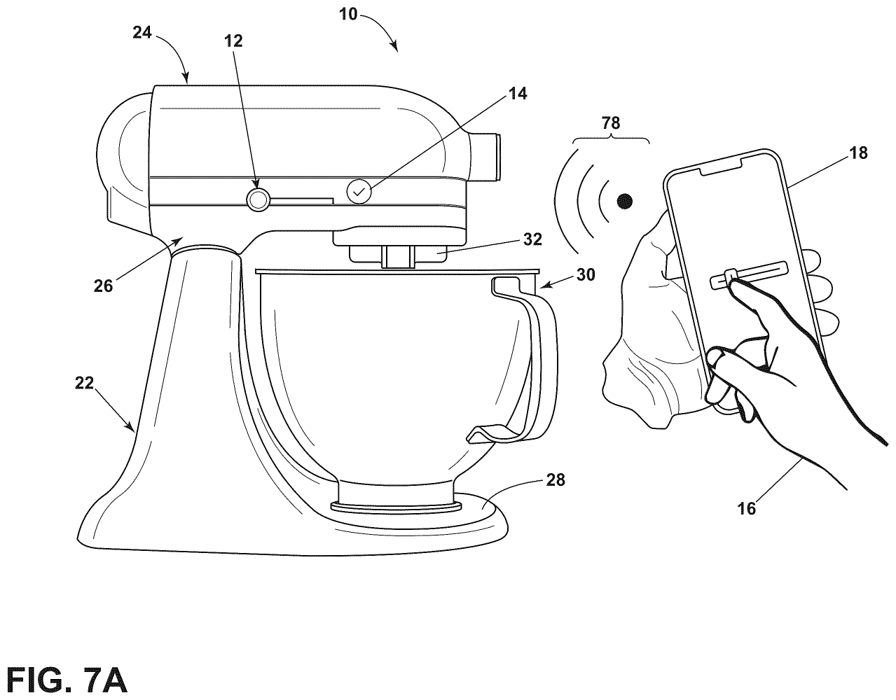

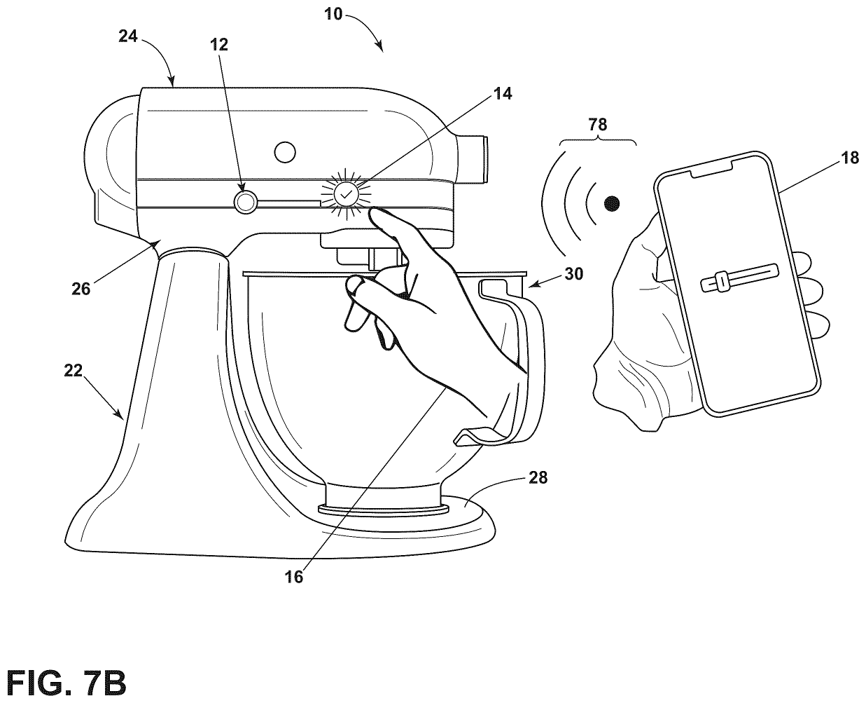

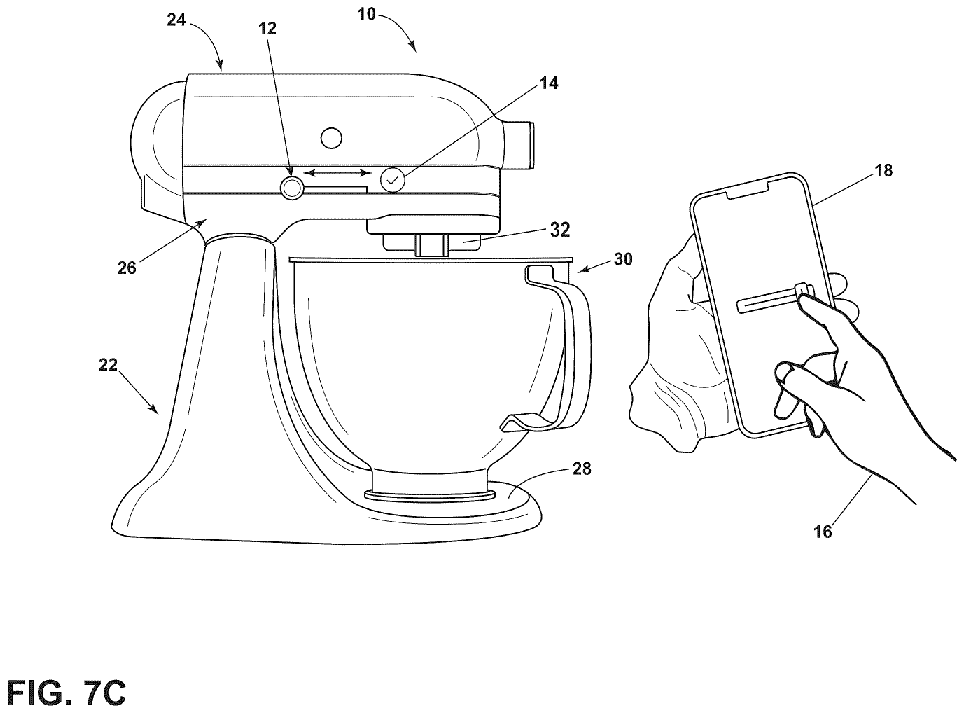

Turning to the embodiment of FIGS. 7A and 7B, a user (shown in an illustrative example by a user's hand 16), is shown updating a suitable interface on a smartphone 18 representative of the actuator 12 on the countertop appliance. With a suitable application programming interface resident on the smartphone device 18, a wireless signal, shown by example with reference numeral 78, is emitted to the countertop appliance as shown in FIG. 7A. Turning to FIG. 7B, an optional step is shown in which the confirmation interface 14 is placed into an active state indicating to the user that a user adjacent to the countertop appliance that a remote signal has been received to update the desired operational criteria of the countertop appliance, such as motor speed. A user can then provide one or more of a plurality of gestures to the confirmation interface 14, such as to confirm the updated operational criteria, cancel the updated operational criteria, or other updates to the microprocessor 36 through the confirmation interface 14 as would be apparent to one skilled in the art. Turning to FIG. 7C, if a user has updated the operational criteria of the countertop appliance via the smartphone device 18, and provided the optional acceptance of the updated operational criteria via the confirmation interface 14, the physical position of the handle 40 of the actuator 12 will move to reflect the updated setting received via the smartphone device 18.

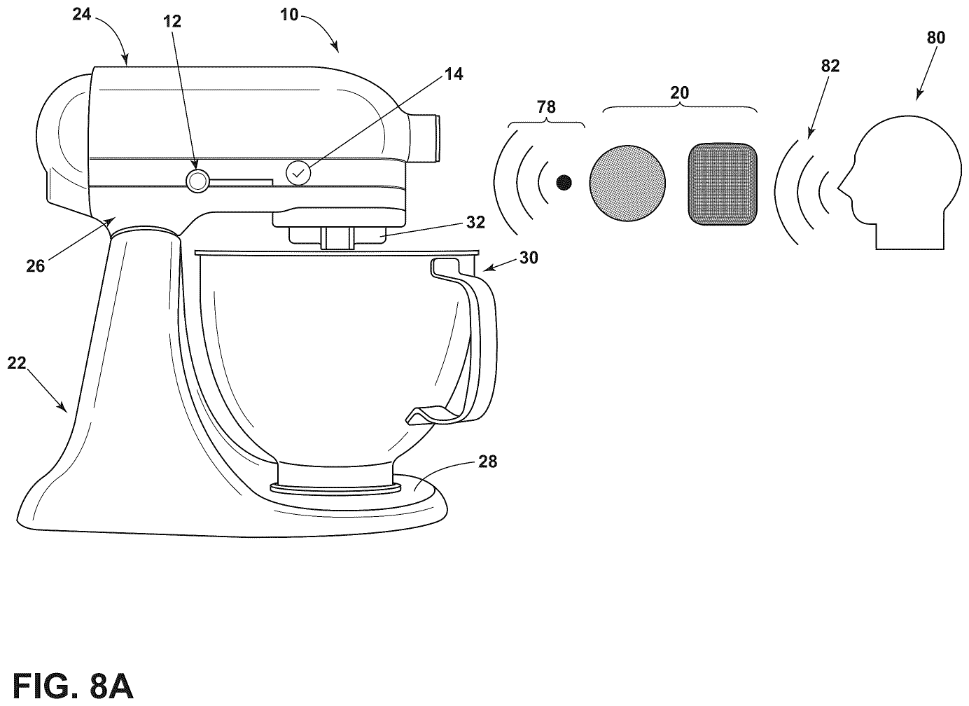

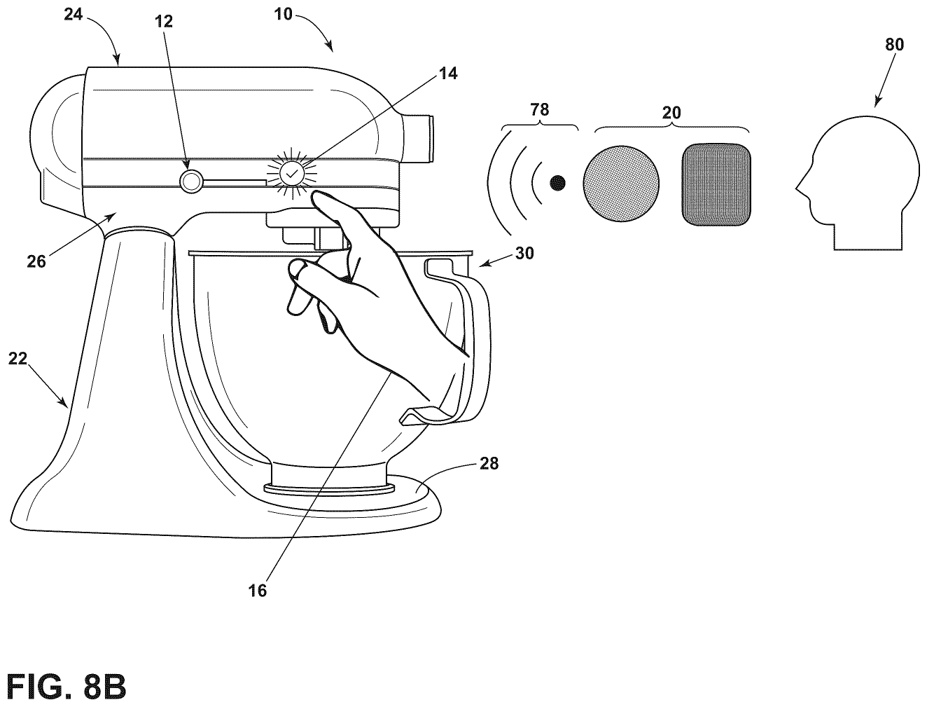

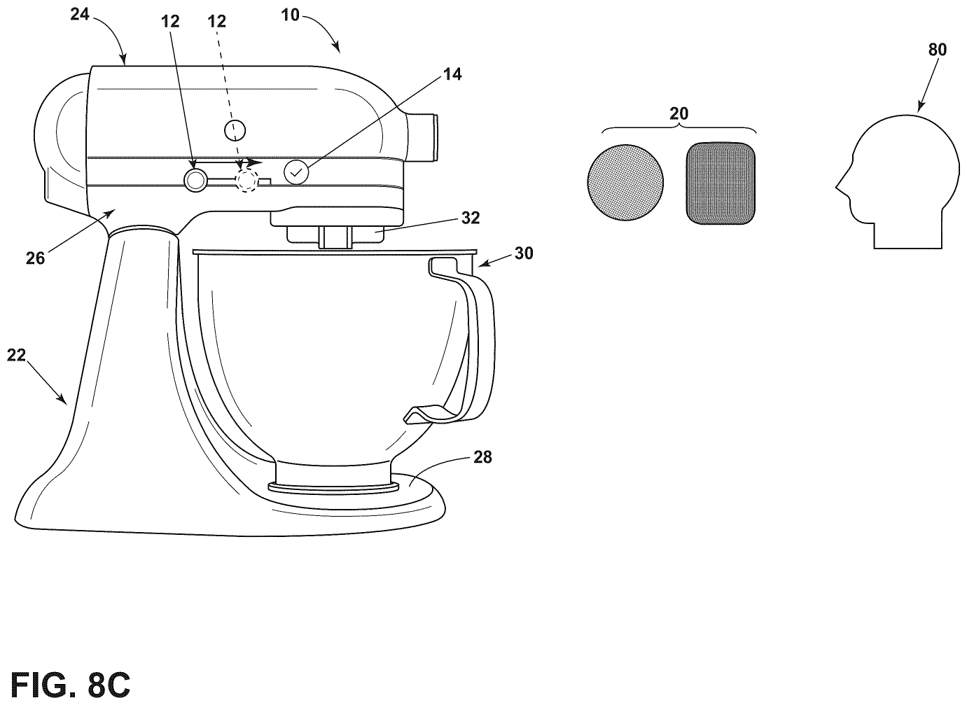

Turning to FIGS. 8A-8C, a similar operation to that illustrated with respect to FIG. 7A-7C is provided except that a user 80 can issue a voice command 82 via a home automation device 20 which can thereby emit a wireless signal 78 to the countertop appliance 10. Examples of voice commands could be as simple as “speed faster” or “speed slower” or appliance off” and the like. Definitions of these commands could be set via a suitable application paired with the home automation device 20 in a manner that would be apparent to one skilled in the art. In an optional confirmation step shown in FIG. 8B similar to that described with respect to FIG. 7B, the confirmation interface 14 could be set to an active state indicating to a user to provide a gesture representative of an acceptance or cancellation or other operational command as defined by an application programming interface interconnected with the countertop appliance 10 or home automation device 20. As shown in FIG. 8C, if a wireless signal 78 has been received via a home automation device 20 and confirmed by the optional step as described with respect to FIG. 8B, the physical position of the handle 40 with respect to the actuator 12 will move with respect to the actuator 12 to the desired updated position representative of the command received by the countertop appliance 10.

To the extent not already described, the different features and structures of the various embodiments of the present disclosure may be used in combination with each other as desired. That one feature may not be illustrated in all of the embodiments is not meant to be construed that it cannot be but is done for brevity of description. Thus, the various features of the different embodiments may be mixed and matched as desired to form new embodiments, whether or not the new embodiments are expressly described.

While aspects of the present disclosure have been specifically described in connection with certain specific embodiments thereof, it is to be understood that this is by way of illustration and not of limitation. Reasonable variation and modification are possible within the scope of the forgoing disclosure and drawings without departing from the spirit of the present disclosure which is defined in the appended claims.

What is claimed is:

1. A countertop appliance comprising:
a base having a lower surface for resting on a work surface and an upper portion, the lower surface having an extension upon which a mixing bowl can be placed for food preparation operations performed by the countertop appliance;
a housing comprising a rotatable attachment mount;
a motor having an output shaft operably connected to the attachment mount and configured to provide rotational motion to the attachment mount when powered;
an actuator mounted to at least one of the base or the housing and operably interconnected with the motor, the actuator having a handle movable along a path that is accessible from the exterior of the countertop appliance by a user and a positioning assembly configured to impart movement to the handle of the actuator along the path upon receipt of a position signal by the positioning assembly;
a wireless communication interface operably interconnected with the positioning assembly adapted to provide the position signal to the positioning assembly;
wherein, upon receipt of the position signal by the positioning assembly or physical movement of the handle of the actuator by a user, movement of the handle of the actuator between a plurality of positions generates a signal from the actuator to the motor representative of a speed of the output shaft of the motor.

2. The countertop appliance of claim 1 wherein the wireless communication interface is at least one of WiFi or Bluetooth communication protocols.

3. The countertop appliance of claim 1 wherein the handle of the actuator comprises a knob.

4. The countertop appliance of claim 1 wherein the path along which the handle of the actuator moves is linear.

5. The countertop appliance of claim 1 wherein the path along which the handle of the actuator moves is arcuate.

6. The countertop appliance of claim 1 and further comprising a tactile interface having at least one visual indicator thereon that is accessible by a user from the exterior of the countertop appliance operably interconnected between the actuator and the motor.

7. The countertop appliance of claim 6 wherein the visual indicator is controllable between a first inactive state and a second active state.

8. The countertop appliance of claim 7 and further comprising a signal interrupt that prevents any position signals from affecting the position of the handle along the when the visual interface of the tactile interface is set to the second active state.

9. The countertop appliance of claim 8 wherein the tactile interface is configured to return the visual indicator to the first inactive state upon receipt of a first gesture from a user and any pending position signals are processed by the actuator.

10. The countertop appliance of claim 9 wherein the tactile interface is configured to return the visual indicator to the first inactive state upon receipt of a second gesture from a user and any pending position signals are canceled by the actuator.

11. The countertop appliance of claim 1 wherein the actuator comprises an elongated housing having a first end and a second end and the handle is mounted for movement to the elongated housing between the first and second ends thereof.

12. The countertop appliance of claim 11 wherein the handle includes at least one of a flange and a slot, and the elongated housing includes the other of the flange and a slot, and the flange is mounted for slidable movement within the slot to define the path.

13. The countertop appliance of claim 12 wherein the positioning assembly comprises a positioning motor controllable by the position signal, and an output of the motor is operably interconnected to the handle of the actuator to impart movement thereto representative of the position signal.

14. The countertop appliance of claim 12 wherein the output of the positioning motor further comprises a gear, the elongated housing comprises a belt mounted for movement imparted from rotation of the gear by the motor, and movement of the belt imparts slidable movement of the handle with respect to the elongated housing.

15. The countertop appliance of claim 12 wherein the output of the positioning motor further comprises a gear rotatable by the positioning motor and the handle further comprises a rack gear engaged with the gear of the positioning motor, wherein rotation of the positioning motor gear imparts lateral movement of the handle with respect to the elongated housing.

16. The countertop appliance of claim 12 wherein the output of the positioning motor further comprises a worm gear extending along the general direction of the elongated housing and the handle further comprises a gear engaged with the worm gear, wherein rotation of the positioning motor worm gear imparts lateral movement of the handle with respect to the elongated housing.

17. A countertop appliance comprising:
a base having a lower surface for resting on a work surface and an upper portion, the lower surface having an extension upon which a mixing bowl can be placed for food preparation operations performed by the countertop appliance;
a housing comprising a rotatable attachment mount, at least one of the housing and the base movable with respect to the other of the housing and the base between at least a first position wherein the attachment mount is juxtaposed with the extension on the lower surface of the base, and a second position wherein the attachment mount is moved away from the extension on the lower surface of the base;
a motor having an output shaft operably connected to the attachment mount and configured to provide rotational motion to the attachment mount when powered;
an actuator mounted to at least one of the base or the housing and operably interconnected with the motor, the actuator having a handle movable along a path that is accessible from the exterior of the countertop appliance by a user and a positioning assembly configured to impart movement to the handle of the actuator along the path upon receipt of a position signal by the positioning assembly, wherein the actuator comprises a first end and a second end and the handle is mounted for movement between the first and second ends thereof;
a wireless communication interface operably interconnected with the positioning assembly adapted to provide the position signal to the positioning assembly;
wherein, upon receipt of the position signal by the positioning assembly or physical movement of the handle of the actuator by a user, movement of the handle of the actuator between a plurality of positions generates a signal from the actuator to the motor representative of a speed of the output shaft of the motor.

18. The countertop appliance of claim 17 wherein the positioning assembly comprises a positioning motor controllable by the position signal, and an output of the motor is operably interconnected to the handle of the actuator to impart movement thereto representative of the position signal.

19. The countertop appliance of claim 18 wherein the output of the positioning motor further comprises a gear, the elongated housing comprises a belt mounted for movement imparted from rotation of the gear by the motor, and movement of the belt imparts slidable movement of the handle with respect to the elongated housing.

20. The countertop appliance of claim 17 wherein the countertop appliance comprises a stand mixer and the rotatable accessory mount is adapted to receive a mixing accessory.
